(19) United States
(12) Patent Application Publication
(10) Pub. No.: US 2009/0174545 A1
(43) Pub. Date: Jul. 9, 2009

(54) ALARM SYSTEM AND METHOD VIA ELECTRONIC MAIL

(75) Inventors: CHI-CHIH WANG, Tu-Cheng (TW); YONG-HUA SONG, Shenzhen City (CN); RUI-JUN WANG, Shenzhen City (CN); SHAN-SHENG WU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/344,571

(22) Filed: Dec. 28, 2008

(30) Foreign Application Priority Data
Jan. 9, 2008 (CN) 200810300049.3

(51) Int. Cl. G08B 1/00

(52) U.S. Cl. 340/531

(57) ABSTRACT

An alarm system for sending alarm e-mails flexibly defines various alarm conditions and alarm procedures according to a predetermined reference. The alarm system obtains monitoring data from a monitor system, and determines if the monitoring data meets any of the alarm conditions. The alarm system correspondingly selects an alarm procedure, generates alarm e-mails, and sends the alarm e-mails according to the alarm procedure.

### FIELD OF THE INVENTION

Embodiments of the present disclosure relate to electronic alarms, and particularly to an alarm system and method via electronic mail (e-mail).

### DESCRIPTION OF RELATED ART

In a network system, e-mails are a common way to broadcast information. For example, alarm e-mails may be sent out when emergencies occur in a manufacturing plant. Alarm procedures are expected to vary with alarm conditions in some cases. For example, a first alarm procedure is desired under a first alarm condition, and a second alarm procedure is desired under a second alarm condition. As such, different alarm e-mails may be sent to different users in different sequences.

### BRIEF DESCRIPTION OF THE DRAWINGS

FIG. 1 is a block diagram of one embodiment of an alarm system via e-mails.

FIG. 2 is a block diagram of one embodiment of an alarm unit comprising function modules.

FIG. 3 is a flowchart of one embodiment of an alarm method via e-mails.

### DETAILED DESCRIPTION OF CERTAIN INVENTIVE EMBODIMENTS

All of the processes described below may be embodied in, and fully automated via, function code modules executed by one or more general purpose computers or processors. The code modules may be stored in any type of computer-readable medium or other computer storage device. Some or all of the methods may alternatively be embodied in specialized computer hardware.

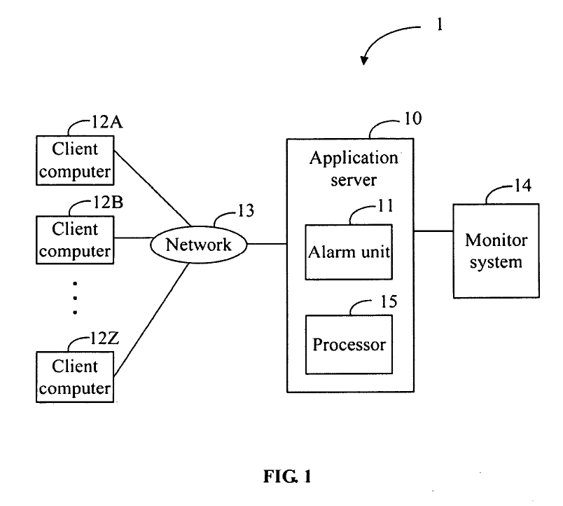

FIG. 1 is a block diagram of one embodiment of an alarm system 1 to send alarm e-mails in response to various alarm conditions. In one embodiment, the alarm system 1 may include an application server 10, client computers 12A-12Z, and a monitor system 14. The application server 10 is connected to the client computers 12A-12Z over a network 13, such as the Internet, or an intranet. The application server 10 is further connected to the monitor system 14.

The application server 10 may include an alarm unit 11 and a processor 15. The alarm unit 11 may define various alarm conditions and alarm procedures according to a predetermined reference. The alarm unit 11 retrieves monitoring data from the monitor system 14, and determines if the monitoring data meets any of the alarm conditions. Correspondingly, the alarm unit 11 selects an alarm procedure from the alarm procedures according to the monitoring data and the alarm conditions. Then the alarm unit 11 generates alarm e-mails, and sends the alarm e-mails according to the selected alarm procedure.

Each of the client computers 12A-12Z provides a user interface for receiving and displaying the alarm e-mails from the application server 10 over the network 13. The client computers 12A-12Z may include any type of electronic data processing systems or communication devices. Examples of such electronic data processing system include personal computer systems, such as desktop or laptop computers, personal digital assistants (PDAs). Examples of such communication device include cellular telephones.

The monitor system 14 collects the monitoring data for the application server 10, and stores the monitoring data into a storage system, such as a database system. In one example, the monitor system 14 may be a statistical process control (SPC) system, which collects the monitoring data from a manufacturing plant. The monitoring data collected by the SPC system may include a yield rate and a daily production of the manufacturing plant.

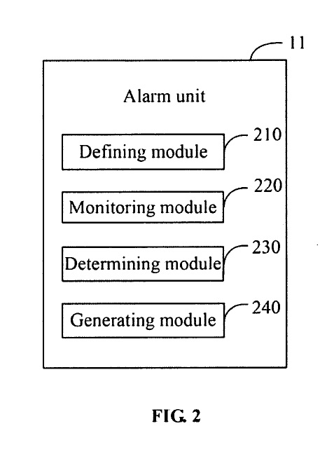

FIG. 2 is a block diagram of one embodiment of the alarm unit 11 comprising function modules. In one embodiment, the alarm unit 11 may include a defining module 210, a monitoring module 220, a determining module 230, and a generating module 240. One or more specialized or general purpose processors, such as the processor 15 may be used to execute one or more operations for the defining module 210, the monitoring module 220, the determining module 230, and the generating module 240.

The defining module 210 is configured for defining user information, the alarm conditions, and the alarm procedures. The user information may include a user name, an e-mail address, and a user ID of each user that may receive alarm e-mails. The e-mail address may be associated with the user name and the user ID, so that the e-mail address is retrieved according to the user name or the user ID. The defining module 210 may define various user groups according to the user information, each of which includes more than one user. For example, a user group A included users A0, A1, A2, A3, and A4.

Each of the alarm conditions may be based upon a single condition or a combination of multiple conditions. In one example of a single condition, a yield rate of a manufacturing plant may be below 98 percent. In one example of a combination of multiple conditions, the yield rate of the manufacturing plant may be below 98 percent, and a daily production of the manufacturing plant may be less than 10000 units.

The alarm procedures may be defined according to the user information. In one embodiment, the defining module 210 may define the alarm procedures according to the user groups. For example, the alarm e-mails may be sent to a user group, such as the user group A in an alarm procedure.

The monitoring module 220 is configured for retrieving the monitoring data from the monitor system 14. In one embodiment, the monitoring module 220 retrieves the monitoring data at a predetermined interval, for example, every half an hour.

The determining module 230 is configured for determining if the monitoring data meets any of the alarm conditions. The determining module 230 is further configured for selecting an alarm procedure from the alarm procedures according to the monitoring data and the alarm conditions. In one example, the defining module 210 defines an alarm condition and an corresponding alarm procedure. Accordingly, the determining module 230 selects the alarm procedure if the monitoring data meets the alarm condition.

The generating module 240 is configured for generating alarm e-mails, and sending the alarm e-mails according to the selected alarm procedure. As such, different alarm e-mails may be sent to different users in different sequences.

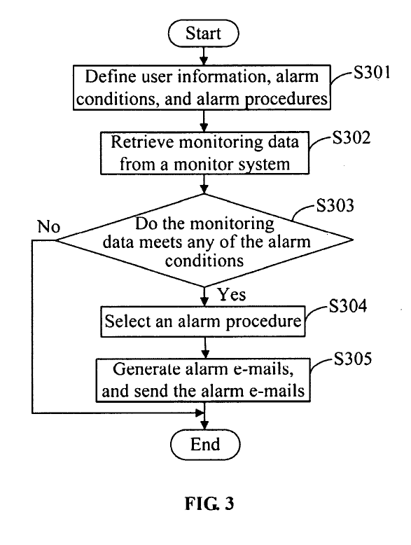

FIG. 3 is a flowchart of one embodiment of a method to send alarm e-mails in response to various alarm conditions by implementing the alarm system of FIG. 1. In one embodiment, the method of FIG. 3 may be used to send alarm e-mails for a manufacturing plant in response to a change of yield or a change in production units, for example. Depending on the embodiments, additional blocks may be added, others removed, and the ordering of the blocks may be changed.

In block 301, the defining module 210 defines user information, alarm conditions, and alarm procedures. The user information may include a user name, an e-mail address, and a user ID of each user that may receive alarm e-mails.

The defining module 210 may define various user groups for the users. In one example, there are 16 users named E, A0-A4, B0-B4, C0-C4. The defining module 210 defines four user groups for the 16 users. A first user group named A includes A0, A1, A2, A3, and A4. A second user group named B includes B0, B1, B2, B3, and B4. A third user group named C includes C0, C1, C2, C3, and C4. A fourth user group named L includes A0, B0, and C0.

Each of the alarm conditions may be a single condition or a combination of multiple conditions. As mentioned above, a single condition may be that a yield rate of a manufacturing plant is below 98 percent and a combination of multiple conditions may be that the yield rate of the manufacturing plant is below 98 percent, and a daily production of the manufacturing plant is less than 10000 units.

The alarm procedures may be used to define different alarm procedures according to the user information. In one embodiment, each of the alarm procedures corresponds to one of the alarm conditions. For example, a first alarm procedure corresponding to a first alarm condition may be defined as follows: (1) sending to A1; (2) sending to B1; (3) sending to C1. A second alarm procedure corresponding to a second alarm condition may be defined as follow: (1) sending to A2; (2) sending to B2; (3) sending to C2.

The defining module 210 may define the alarm procedures according to the user groups. For example, an alarm procedure may be defined as follows: (1) sending to A1 as well as sending a copy to user group A; (2) sending to B1 as well as sending a copy to user group B; (3) sending to C1 as well as sending a copy to user group C.

In block 302, the monitoring module 220 retrieves monitoring data from the monitor system 14. The monitoring module 220 may retrieve the monitoring data at a predetermined interval, for example, every half an hour. In one embodiment, the monitor system 14 may be a statistical process control (SPC) system, which obtains the monitoring data from a manufacturing plant. The monitoring data may include a yield rate of the manufacturing plant. For example, the monitoring module 220 retrieves a yield rate of 95 percent.

In block 303, the determining module 230 determines if the monitoring data meets any of the alarm conditions. In one example, an alarm condition is that the yield rate is below 98 percent. Therefore, the yield rate of 95 percent meets the alarm condition. The flow may go to the end if the monitoring data do not meet any of the alarm conditions.

In block 304, the determining module 230 selects an alarm procedure from the alarm procedures. In one embodiment, the determining module 230 selects the alarm procedure according to a relationship between each of the alarm procedures and the alarm conditions. For example, the selected alarm procedure may be as follows: (1) sending to A1 as well as sending a copy to the user group A; (2) sending to B1 as well as sending a copy to the user group B; (3) sending to C1 as well as sending a copy to the user group C.

In block 305, the generating module 240 generates alarm e-mails according to the alarm condition that the monitoring data meets, then sends the alarm e-mails according to the alarm procedure. As such, different alarm e-mails may be sent to different users in different sequence. For example, the generating module 240 generates alarm e-mails containing an alarm message “The yield rate is below 98 percent! Please process it!” The above alarm e-mails are sent as follows: (1) sending to A1 as well as sending a copy to the user group A; (2) sending to B1 as well as sending a copy to the user group B; (3) sending to C1 as well as sending a copy to the user group C.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An alarm system for sending alarm electronic mails (e-mails) according to alarm conditions, the alarm system comprising:
a defining module configured for defining user information, the alarm conditions, and alarm procedures, wherein the alarm procedures are defined according to the user information;
a monitoring module configured for retrieving monitoring data from a monitor system;
a determining module configured for determining if the monitoring data meets any of the alarm conditions, and selecting an alarm procedure from the alarm procedures according to the determination;
a generating module configured for generating alarm e-mails, and sending the alarm e-mails according to the selected alarm procedure; and
at least one processor that executes the defining module, the monitoring module, the determining module, and the generating module.

2. The system of claim 1, wherein the defining module further defines one or more user groups, and wherein the alarm procedures are defined according to the one or more user groups.

3. The system of claim 1, wherein the monitoring module retrieves the monitoring data from the monitor system at a predetermined interval.

4. The system of claim 1, wherein each of the alarm procedures corresponds to one of the alarm conditions, and wherein the selected alarm procedure is selected according to a relationship between each of the alarm procedures and the alarm conditions.

5. The system of claim 1, wherein the user information comprises a user name, an e-mail address, and a user ID of each user.

6. A computer-implemented alarm method for sending electronic mails (e-mails) according to alarm conditions, the alarm method comprising:
defining user information, the alarm conditions, and alarm procedures, wherein the alarm procedures are defined according to the user information;
retrieving monitoring data from a monitor system;
determining if the monitoring data meets any of the alarm conditions, and selecting an alarm procedure from the alarm procedures according to the determination; and
generating alarm e-mails, and sending the alarm e-mails according to the selected alarm procedure.

7. The method of claim 6, wherein the alarm procedures are defined according to one or more predefined user groups.

8. The method of claim 6, wherein the monitoring data are retrieved from the monitor system at a predetermined interval.

9. The method of claim 6, wherein each of the alarm procedures corresponds to one of the alarm conditions, and wherein the selected alarm procedure is selected according to a relationship between each of the alarm procedures and the alarm conditions.

10. The method of claim 6, wherein the user information comprises a user name, an e-mail address, and a user ID of each user.

11. A computer-readable medium having stored thereon instructions that, when executed by a computerized device, cause the computerized device to execute a computer-implemented method comprising:
defining user information, the alarm conditions, and alarm procedures, wherein the alarm procedures are defined according to the user information;
retrieving monitoring data from a monitor system;
determining if the monitoring data meets any of the alarm conditions, and selecting an alarm procedure from the alarm procedures according to the determination; and
generating alarm e-mails, and sending the alarm e-mails according to the selected alarm procedure.

12. The medium of claim 10, wherein the alarm procedures are defined according to one or more predefined user groups.

13. The medium of claim 10, wherein the monitoring data are retrieved from the monitor system at a predetermined interval.

14. The medium of claim 10, wherein each of the alarm procedures corresponds to one of the alarm conditions, and wherein the selected alarm procedure is selected according to a relationship between each of the alarm procedures and the alarm conditions.

15. The medium of claim 10, wherein the user information comprises a user name, an e-mail address, and a user ID of each user.
